(19) United States
(12) Patent Application Publication
(10) Pub. No.: US 2026/0283112 A1
(43) Pub. Date: Sep. 24, 2026

(54) THREE-DIMENSIONAL AVOIDANCE ZONE DEVICE FOR ANIMAL CONTROL

(71) Applicant: William P. Moore, Knoxville, TN (US)

(72) Inventor: William P. Moore, Knoxville, TN (US)

(21) Appl. No.: 19/088,258

(22) Filed: Mar. 24, 2025

(51) Int. Cl. A01K 15/02; A01K 11/00; A01K 27/00; A01K 29/00; G06F 3/01

(52) U.S. Cl. CPC A01K 15/023; A01K 11/008; A01K 27/009; A01K 29/005; G06F 3/011

(57) ABSTRACT

An avoidance zone device is provided to define one or more avoidance zones in three-dimensional space. The avoidance zone device includes a position sensor and, in some instances, an orientation sensor. The avoidance zone device further includes a transmitter that transmits the position and optionally, the orientation, of the avoidance zone device. An avoidance space is defined based on the position of the avoidance zone device and a definition of the avoidance zone defining a three-dimensional space. The avoidance zone device can be used with a system controller that stores the defined avoidance space. The system controller can further be used with a roving device, determining whether the roving device has entered the defined avoidance space.

### BACKGROUND

Various types of animal behavioral control devices have been developed that discourage or encourage various types of animal behavior. For example, bark control collar devices may issue an audible or electrical stimulus in response to detecting a dog bark. Virtual fence systems may be used, which can include radio frequency (RF) signaling, global positioning system (GPS), or other types of location systems to monitor a position of an animal and either issue notifications to animal owners, or stimulus to the animals, to encourage such animals to remain within particular physical locations.

In some known configurations, a physical device may include a wireless signal emitter. Signals emitted from such a device may be detected at an animal tracking device, such as a pet collar. The animal tracking device may issue various notifications to an animal in the form of positive or negative stimulus/reinforcement, or send a notification to an owner of the animal via a separate communication (e.g., via text or application notification, email, or the like).

Such systems generally have drawbacks. For example, physical devices that include wireless emitters (e.g., sometimes referred to as beacons) may generally emit omnidirectional wireless signals, causing those devices to induce a response from an animal tracking device once an animal tracking device observes a predetermined detected signal strength. The observed signal strength roughly corresponds to a distance between the physical device, or beacon, and the animal tracking device. This distance is typically in all directions, but attenuates quickly when passing through walls, floors, ceilings, or other physical objects. Accordingly, a user has only limited control in terms of the manner of definition of the region in which a response from an animal tracking device is desired.

### SUMMARY

An avoidance zone device can allow an avoidance space to be defined within a three-dimensional space. The avoidance space can be used to set rules for the location of a roving device, such as a pet collar. By defining an avoidance space with respect to a position and an orientation of the avoidance zone device, the avoidance space can allow for rules to be defined accounting for three-dimensional space. For example, an avoidance space can be defined that exists only between a top of a table and a ceiling, while allowing a pet to move below the table or through an area on another floor that may be above or below said table. The avoidance zone device can operate by transmitting data defining the avoidance space. By transmitting the definition of the avoidance space, instead of using a receiver to detect proximity of the roving device, the power consumption at the avoidance zone device can be limited, providing significant battery life for the avoidance zone device. The avoidance spaces can be stored by a system controller, allowing a single avoidance zone device to optionally be used to define a plurality of avoidance spaces.

In an embodiment, an avoidance zone device includes a position sensor configured to obtain a position of the avoidance zone device, an orientation sensor configured to determine an orientation of the avoidance zone device, a control interface configured to receive a definition of an avoidance zone, and a transmitter configured to transmit data including the position of the avoidance zone device, the orientation of the avoidance zone device, and the definition of the avoidance zone.

In an embodiment, the avoidance zone device can be disc shaped. The position sensor can include an ultra-wide-band (UWB) transceiver or a global navigation satellite system (GNSS) transceiver. The orientation sensor can include an accelerometer. The definition of the avoidance zone can include a diameter of the avoidance zone or a height of the avoidance zone. The control interface can be configured to receive the definition of the avoidance zone through manual input or wireless communications.

In an embodiment, a system includes an avoidance zone device. The avoidance zone device includes a position sensor configured to obtain a position of the avoidance zone device, an orientation sensor configured to determine an orientation of the avoidance zone device, and a transmitter configured to transmit data including the position of the avoidance zone device and the orientation of the avoidance zone. The system further includes a system controller. The system controller includes a processor configured to receive the position of the avoidance zone device, the orientation of the avoidance zone device, and a definition of the avoidance zone, and to determine an avoidance space based on the position of the avoidance zone device, the orientation of the avoidance zone device, and the definition of the avoidance zone. The system controller further includes a memory configured to store the avoidance space.

In an embodiment, the system controller is configured to receive the data including the position of the avoidance zone device, the orientation of the avoidance zone device, and the definition of the avoidance zone from the avoidance zone device. In an embodiment, the system controller is configured to receive a second position of the avoidance zone device, a second orientation of the avoidance zone device, and a second definition of the avoidance zone, and determine a second avoidance space based on the position of the avoidance zone device, the orientation of the avoidance zone device, and the definition of the avoidance zone.

In an embodiment, the system further includes an application executable on a processor of a mobile device, wherein the application and at least one of the system controller or the avoidance zone device are configured to communicate through wireless communications. The application can be configured to receive the position of the avoidance zone device and the orientation of the avoidance zone device, and the system controller is configured to receive the position of the avoidance zone device, the orientation of the avoidance zone device, and the definition of the avoidance zone from the application. The application can be configured to obtain the definition of the avoidance zone and the system controller is configured to receive the definition of the avoidance zone from the application. The application can be configured to display an augmented reality view of a location including at least a portion of the avoidance space, the augmented reality view showing the avoidance space.

In an embodiment, the system further includes a roving device. The roving device includes a position sensor configured to determine a position of the roving device and a transmitter configured to transmit the determined position of the roving device. The system controller is configured to receive the determined position of the roving device and determine whether the determined position of the roving device is within the avoidance space.

In an embodiment, a method includes determining a position of an avoidance zone device using a position sensor included in the avoidance zone device. The method also includes determining an orientation of the avoidance zone device using an orientation sensor included in the avoidance zone device. The method also includes obtaining a definition of an avoidance zone using a control interface of the avoidance zone device. The method further includes transmitting, from the avoidance zone device, data including the position of the avoidance zone device, the orientation of the avoidance zone device, and the definition of the avoidance zone.

In an embodiment, the method further includes receiving the data at a system controller and determining, at the system controller, an avoidance space based on the position of the avoidance zone device, the orientation of the avoidance zone device, and the definition of the avoidance zone. In an embodiment, the method also includes receiving position data from a roving device at the system controller and determining whether the roving device has entered the avoidance zone.

In an embodiment, the method further includes determining a second position of an avoidance zone device using the position sensor included in the avoidance zone device, determining a second orientation of the avoidance zone device using the orientation sensor included in the avoidance zone device, and transmitting, from the avoidance zone device, second data including the second position of the avoidance zone device and the second orientation of the avoidance zone device. In this embodiment, the method also further includes receiving the second data at the system controller and determining, at the system controller, a second avoidance space based on the second position of the avoidance zone device and the second orientation of the avoidance zone device.

### BRIEF DESCRIPTION OF THE DRAWINGS

FIG. 1A illustrates an avoidance zone device according to an embodiment.

FIG. 1B illustrates the avoidance zone device of FIG. 1A.

FIG. 2 illustrates an animal response zone control system according to an embodiment.

FIG. 3 illustrates an animal response zone control system according to an embodiment.

FIG. 4 illustrates an avoidance zone defined by an avoidance zone device according to an embodiment.

FIG. 5 illustrates avoidance zones define by an avoidance zone device according to an embodiment.

FIG. 6 illustrates a method according to an embodiment.

FIG. 7 shows a user interface including a visualization of an avoidance zone according to an embodiment.

### DETAILED DESCRIPTION

As briefly described above, embodiments of the present invention are directed to an avoidance zone device that includes a wireless signal transmitter and an orientation sensor. The avoidance zone device may include as a signal transmitter. The signal transmitter may emit a signal that includes the location and orientation of the avoidance zone device. The avoidance zone device can include a control interface obtaining characteristics of the avoidance zone such as diameter, height, or any other suitable size and shape parameters for the avoidance zone.

In some embodiments, the avoidance zone device may use ultrawideband (UWB) communications to determine its position relative to a base station, which may act as a UWB anchor. The avoidance zone device may alternatively use global navigation satellite systems (GNSS), BlueTooth, BlueTooth Low Energy (BLE), or any other suitable technology for determining the position of the avoidance zone device. In some embodiments, the position of the avoidance zone device can be further refined by way of real-time kinematics or post-processing kinematics. Non-limiting examples of systems using real-time kinematics and/or post-processing kinematics are provided in U.S. application Ser. No. 18/941,818, which is herein incorporated by reference in its entirety.

In some embodiments, the orientation sensor includes an accelerometer. The orientation sensor enables a user to define an orientation of the avoidance zone, for example having the avoidance zone be oriented in a vertical direction, a horizontal direction, a direction including both vertical and horizontal components, or the like.

In some instances, an animal response zone control system is provided that includes one or more avoidance zone devices and a system controller. The system controller can receive the position and orientation data transmitted by the avoidance zone device, and define an avoidance zone based on the position and orientation of the avoidance zone device. The system controller can determine whether a roving device, for example an animal tracking device such as an animal collar, has entered a defined avoidance zone. The system controller can optionally further trigger an automated action based on entry of the roving device into the avoidance zone. Optionally, a mobile device can interface with one or both of the avoidance zone device and the system controller, for example to allow input of parameters defining the avoidance zone, to provide visualizations of one or more defined avoidance zones, to facilitate communications between the avoidance zone devices and the system controller, or the like.

In some instances, the avoidance zone device may have machine-readable indicia disposed thereon which, when read by a user's mobile device, may indicate an identity of the avoidance zone device. A user's mobile device, upon scanning such machine-readable indicia, may be led to a network location at which characteristics of the avoidance zone device are displayed. In some instances, a virtual display may be generated that depicts, using an augmented reality display on the user's mobile device, an overlay of a simulated avoidance zone in proximity to the avoidance zone device based on the settings and orientation of the avoidance zone device.

By contrast to existing solutions, the use of a physical device to define a three-dimensional avoidance zone enables more user-friendly, granular control over such avoidance zones. Existing attempted solutions would either use omnidirectional radio frequency beacon technologies, or would define analytics zone by either (1) movement of an animal tracking device within the intended avoidance zone while that animal tracking device is placed in a “training” mode, or (2) definition of the avoidance zone using a user interface on a mobile device to visualize the space in three dimensions and allow a user to define a shape/position of the avoidance zone. These solutions are generally complex and require significant computational time to define the avoidance zone, as well as to determine whether and when a roving device such as an animal tracking device is positioned within such an avoidance zone. Additionally, omnidirectional beacons may be limited in their potential placements, and may be incapable of defining certain avoidance zones, for example where the avoidance zone is elevated, has a particular height, or the like. In contrast, by capturing orientation data for an avoidance zone device, avoidance zones can be defined with greater flexibility and granularity compared to those defined by omnidirectional beacons.

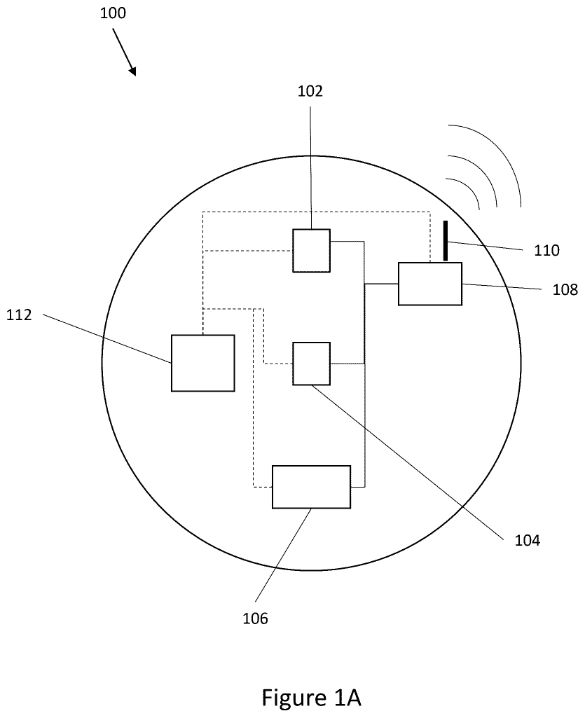

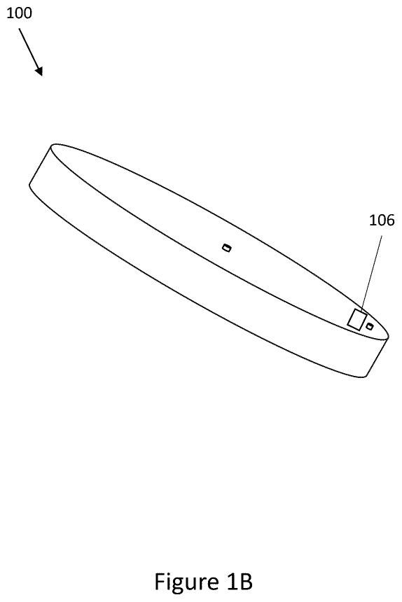

FIG. 1A illustrates an avoidance zone device according to an embodiment. Avoidance zone device 100 includes position sensor 102, control interface 106, processor 108, transmitter 110, and power source 112. In some examples, the avoidance zone device 100 includes orientation sensor 104.

Avoidance zone device 100 is configured to be placed in a location and to provide a location and an orientation about which to define an avoidance space. Avoidance zone device 100 can have any suitable shape to facilitate placement so as to define a position and an orientation of an avoidance zone. The orientation of an avoidance zone can be defined relative to a plane, axis, or other suitable characteristic of the avoidance zone device 100. In an embodiment, avoidance zone device 100 is disc shaped. In an embodiment where the avoidance zone device 100 is disc shaped, an orientation of the avoidance zone can be defined relative to an axis perpendicular to a plane of the disc shape of the avoidance zone device 100. The disc shape of the avoidance zone device 100 is shown in FIG. 1B, along with the plane P and axis A thereof.

Position sensor 102 is a sensor configured to determine a position of the avoidance zone device 100. The position sensor 102 can be configured to determine the position of the avoidance zone device 100 through any suitable technology, such as including an ultra-wide-band (UWB) transceiver, a global navigation satellite systems (GNSS) transceiver, BlueTooth, or the like. In an embodiment, real-time kinematics and/or post processing kinematics can be used to enhance the accuracy of the position sensor 102. The position sensor 102 can define the position of the avoidance zone device according to an existing geographical coordinate system, a position relative to system controller or other device having a fixed position, or the like.

Orientation sensor 104 is a sensor configured to obtain an orientation of the avoidance zone device 100. In embodiments of the avoidance zone device 100 that include the orientation sensor 104, such a sensor can include any suitable sensor capable of determining the orientation of the avoidance zone device 100, for example an accelerometer, a gyroscope, or the like. The orientation of the avoidance zone device 100 can be defined based on a plane, axis, or other suitable characteristic of the avoidance zone device 100, such as plane P or axis A as shown in FIG. 1B. When the avoidance zone device is disc shaped, the orientation detected by the orientation sensor 104 can be defined based on an axis perpendicular to a plane of the disc shape of the avoidance zone device 100. For example, orientation sensor 104 can detect the direction in which the axis perpendicular to the plane of the disc shape of the avoidance zone device 100 extends, such as a vertical direction, a horizontal direction, or a direction having both vertical and horizontal components. The orientation sensor 104 can include any suitable components for determining the orientation of the avoidance zone device, such as one or more accelerometers, gyroscopes, or the like. The orientation sensor 104 can include microelectromechanical systems (MEMS), such as a MEMS accelerometer.

In embodiments of the avoidance zone device 100 that do not include the orientation sensor, the defined avoidance zone may be set to default to a position that is parallel with the ground, or in some other preset, predetermined, or programmable orientation.

Control interface 106 is configured to obtain a definition of an avoidance zone. The definition of the avoidance zone can be a definition of a three-dimensional shape for the avoidance zone. In an embodiment, the three-dimensional shape of the avoidance zone is a cylinder having a diameter and a height. In an embodiment, the diameter can be received at the control interface 106. In an embodiment, the height can be an assumed value or assumed to be infinite. In an embodiment, the height can be received at the control interface 106. In an embodiment, the control interface 106 is configured to receive manual input of parameters defining the avoidance zone. For example, control interface 106 can include physical input devices such as buttons, sliders, dials, a touch screen, or the like. In an embodiment, control interface 106 can present a user interface, for example prompts for input of parameters such as the diameter or height of the avoidance zone. In an embodiment, control interface 106 is configured to obtain parameters defining the avoidance zone from another device, such as a system controller, a mobile device, or the like, for example through a wireless communications connection such as Wi-Fi, BlueTooth, BlueTooth Low Energy (BLE), near-field communications (NFC), or the like. An example of a control interface 106 provided on a surface of the avoidance zone device 100 and configured to receive user input is shown in FIG. 1B.

Processor 108 is configured to receive the position of the avoidance zone device 100 obtained by position sensor 102, the orientation of the avoidance zone device 100 obtained by the orientation sensor 104, and/or parameters obtained at control interface 106. In an embodiment, processor 108 is configured to determine the definition of the avoidance zone based on the parameters obtained at control interface 106. Processor 108 is further configured to direct the transmitter 110 to transmit a signal. In an embodiment, processor 108 can be configured to generate the signal to be transmitted or components thereof by processing one or more of the position of the avoidance zone device 100, the orientation of the avoidance zone device 100, and/or the parameters of the avoidance zone obtained at control interface 106.

Transmitter 110 is configured to transmit the signal. The signal by the transmitter 110 can be any suitable signal for communicating data to another device such as a mobile device, a system controller, or the like, for example according to any suitable communication protocol such as Wi-Fi, BlueTooth, near-field communications (NFC), or the like. The signal includes the position of the avoidance zone device 100 obtained by position sensor 102 and the orientation of the avoidance zone device 100 obtained by the orientation sensor 104. The signal sent by transmitter 110 can further include a definition of the avoidance zone, the definition based on parameters obtained at control interface 106.

In example embodiments, the transmitter 110 is configured to transmit the signal periodically (e.g., one or more times per second). In some instances, the transmitter 110 emits beacon signals 5-20 times per second. In other instances, the transmitter 110 is configurable to emit beacon signals at different frequencies based on a time of day, based on historical interaction with a pet collar, or otherwise as configurable by a user.

Power source 112 is configured to supply power to the position sensor 102, orientation sensor 104, control interface 106, and transmitter 108. Power source 112 can be a power source integrated into the avoidance zone device 100, for example, one or more batteries included in the avoidance zone device. In an embodiment, power source 112 includes one or more rechargeable batteries. In an embodiment, power source 112 can include a connection to an external source of power such as an external battery pack, a wired connection for a wall socket, or the like.

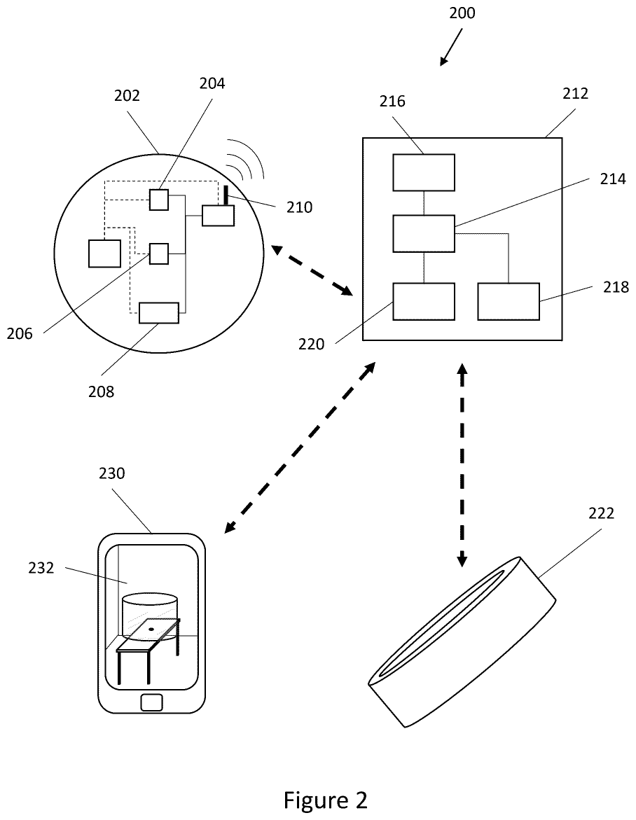

FIG. 2 illustrates an animal response zone control system according to an embodiment. Animal response zone control system 200 can be integrated with a positioning system for use indoors, for example an ultra-wide-band (UWB) system such as a multi-anchor UWB system for three-dimensional positioning. System 200 includes avoidance zone device 202, system controller 212, and can further include roving device 222 and/or mobile device 230. System 200 can further include any other suitable components or devices for determining a position of the roving device 222, monitoring behaviors within a premise, or the like, such as one or more beacons or anchors, such as UWB beacons. Non-limiting examples of beacons and the characteristics and capabilities thereof as part of a monitoring system are provided in U.S. Pat. No. 12,089,565, which is herein incorporated by reference in its entirety.

Avoidance zone device 202 is configured to provide a location, an orientation, and optionally a size and/or shape of an avoidance zone to be implemented by the positioning system including animal response zone control system 200. The avoidance zone can be a space which a roving device 222 or a wearer thereof, such as a pet, is to be excluded from. Non-limiting examples of locations where an avoidance zone may be defined include a tabletop, certain rooms or regions of a dwelling, at or near particular plants or arrangements thereof, or the like. Avoidance zone device 202 can be, as a non-limiting example, disc-shaped and sized so as to be readily movable and capable of being placed in a location where an avoidance zone is to be defined.

In the example shown, avoidance zone device 202 includes position sensor 204, orientation sensor 206, control interface 208, and transmitter 210. Position sensor 204 is configured to obtain a position of the avoidance zone device 202, for example using a transceiver such as a UWB transceiver. Orientation sensor 206 is optional, similar to orientation sensor 104 noted above, and may be configured to determine an orientation of the avoidance zone device 202. Orientation sensor 206 can include an accelerometer, gyroscope, or the like. The avoidance zone device 202 can optionally include control interface 208. Control interface 208 can be configured to receive a definition of the avoidance zone or parameters of such a definition, for example the shape and/or size of said avoidance zone. Control interface 208 can be configured to receive the definition by manual input, input through a user interface thereof, or to receive the definition from another device such as the system controller 212, mobile device 230, or the like. In an embodiment, control interface 208 can optionally be omitted from an avoidance zone device 202, with the definition of the avoidance zone instead being provided at, for example, system controller 212 or by way of an application 232 provided on mobile device 230.

In the example shown, avoidance zone device 202 further includes transmitter 210. Transmitter 210 is configured to transmit a signal including the position of the avoidance zone device 202, the orientation of the avoidance zone device 202, and optionally the definition of the avoidance zone. The transmitter 210 can be configured to transmit the signal directly to system controller 212 or can communicate with the system controller 212 by way of any suitable communications protocol such as Wi-Fi, BlueTooth, BlueTooth Low Energy, cellular data communications such as 4G, 5G, LTE, internet communications, combinations thereof, and the like. Avoidance zone device 202 can further include a processor such as the processor 108 described above and shown in FIG. 1. Avoidance zone device 202 can further include a power source, such as the power source 112 described above and shown in FIG. 1.

Animal response zone control system 200 further includes system controller 212. System controller 212 includes processor 214, memory 216, positioning system 218 and wireless communications 220.

Processor 214 is configured to receive the location and orientation of the avoidance zone device 202, and a definition of the avoidance zone, and to define an avoidance space based on the location and orientation of the avoidance zone device 202, and the definition of the avoidance zone. The location and orientation of the avoidance zone device 202 can be obtained from the signal sent by transmitter 210 of the avoidance zone device 202. The definition of the avoidance zone can be obtained from the signal sent by transmitter 210 of the avoidance zone device 202, from an application 232 of a mobile device 230, input through an interface of the system controller 212, or the like.

Memory 216 can be configured to store program instructions used by processor 214, data such as the position and orientation data received from avoidance zone device 202, data regarding the definition of the avoidance zones including input and/or predetermined data regarding the shape and/or size of the avoidance zone, data regarding the space where an avoidance zone is being established such as maps, floorplans, coordinate data, locations and identifiers of beacons or other devices, or the like. In an embodiment, memory 216 is configured to store at least one avoidance space determined by the processor 214. In an embodiment, memory 216 is configured to store a plurality of avoidance spaces determined by the processor 214, each based on the location and orientation of the avoidance zone device 202 at a different time.

Positioning system 218 can be configured to cooperate with a roving device 222 so as to determine a position of the roving device 222. Positioning system 218 can cooperate with the roving device 222 according to any suitable method of positioning or tracking a roving device 222. The positioning system 218 can, for example, include a transmitter such as a UWB transmitter configured to transmit a signal from which a position of the roving device 222 can be determined. In an embodiment, positioning system 218 can communicate with a plurality of beacons disposed in a space. In an embodiment, positioning system 218 can communicate with the roving device 222, for example to provide correction data such as data based on real-time and/or post-processing kinematics or the like.

Wireless communications 220 can be configured to communicate with one or more of the avoidance zone device 202, the roving device 222, and/or mobile device 230. Wireless communications 220 can include suitable antennas, processors, memories, other circuitry, and the like for directly receiving signals from the avoidance zone device 202 and/or the roving device 222, or for communicating with the avoidance zone device 202, the roving device 222, and/or mobile device 230 by any one or more suitable wireless communications protocols such as Wi-Fi, cellular data communications, BlueTooth, BlueTooth Low Energy, NFC, an internet connection, combinations thereof, or the like.

A roving device 222 can interface with the system controller 212. The roving device 222 can be, for example, an animal tracking device or an animal control device, for example incorporated into an animal collar. The roving device 222 is configured to cooperate with the positioning system 218 of the system controller 210 such that the position of the roving device 222 is monitored by the system controller 210. Roving device 222 can be configured to issue a stimulus responsive to the roving device 222 entering a location, for example when it is detected that the roving device 222 has entered an avoidance zone defined using the avoidance zone device 202.

System 200 can further interface with a mobile device 230 executing an application 232. Mobile device 230 can be a tablet, smartphone, or the like. Mobile device 230 can include memories and processors configured to execute the application 232, and one or more wireless communication transceivers such as for cellular data connections such as 4G, 5G, LTE, and the like, BlueTooth, BlueTooth Low Energy, Wi-Fi, NFC, or the like. Application 232 can be configured to allow a user to manage at least some aspects of the system 200. As a non-limiting example, application 232 can be configured to prompt a user for input of parameters defining an avoidance zone, for example size parameters such as diameter, height, or the like, shape parameters such as the zone being cylindrical or another shape, or the like. The application 232 can be configured to provide the definition of the avoidance zone or constituent parameters to the avoidance zone device 202, system controller 212, or the like, for example using any suitable wireless communications capabilities of the mobile device 230. In an embodiment, the application 232 can be configured to display one or more visualizations of one or more avoidance zones defined using the avoidance zone device 202. The application 232 can receive the orientation, position, size, and shape of the avoidance zone(s) from one or more avoidance zone device 202 and/or system controller 212. In an embodiment, the avoidance zone(s) can be overlaid on an image, for example an image captured by a camera included in the mobile device 230 to create an augmented reality view of a space including at least a portion of an avoidance zone. In an embodiment, the avoidance zone(s) can be shown on a map, a floorplan of a space, a three-dimensional model of a space, in one or more two-dimensional images of the space such as photographs, or the like, such that a viewer can visualize the avoidance zones.

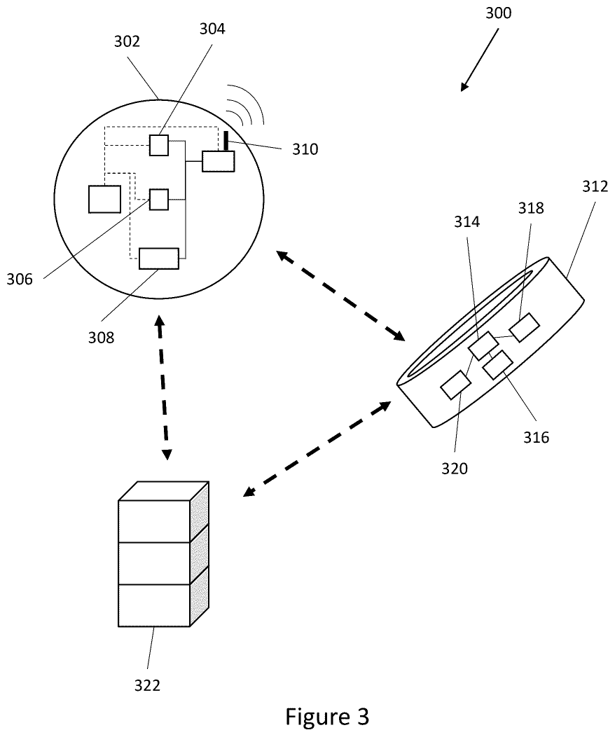

FIG. 3 illustrates an animal response zone control system according to an embodiment. Animal response zone control system 300 can be incorporated into an outdoor positioning system for a roving device 312, such as a positioning system using GNSS. The positioning system can further be enhanced, for example using real-time and/or post-processing kinematics. Animal response zone control system 300 includes avoidance zone device 302 and roving device 312. System 300 can further include server 322.

Avoidance zone device 302 is configured to provide a location, an orientation, and optionally a size and/or shape of an avoidance zone to be implemented by the positioning system including animal response zone control system 300. Avoidance zone device 302 can be, as a non-limiting example, disc-shaped and sized so as to be readily movable and capable of being placed in a location where an avoidance zone is to be defined. Avoidance zone device 302 includes position sensor 304, orientation sensor 306, control interface 308, and transmitter 310. Position sensor 304 is configured to obtain a position of the avoidance zone device 302, for example using a transceiver such as a GNSS transceiver. Orientation sensor 306 is configured to determine an orientation of the avoidance zone device 302. Orientation sensor 306 can include an accelerometer, gyroscope, or the like. The avoidance zone device 302 can optionally include control interface 308. Control interface 308 can be configured to receive a definition of the avoidance zone or parameters of such a definition, for example the shape and/or size of said avoidance zone. Control interface 308 can be configured to receive the definition by manual input, input through a user interface thereof, or to receive the definition from another device such as the server 322, or the like. In an embodiment, control interface 308 can optionally be omitted from an avoidance zone device 302, with the definition of the avoidance zone instead being provided at, for example, server 322. Avoidance zone device 302 further includes transmitter 310. Transmitter 310 is configured to transmit a signal including the position of the avoidance zone device 302, the orientation of the avoidance zone device 302, and optionally the definition of the avoidance zone. The transmitter 310 can be configured to transmit the signal directly to roving device 312 or can communicate with the roving device 312 and/or server 322 by way of internet communications or any suitable protocol thereof. Avoidance zone device 302 can further include a processor such as the processor 108 described above and shown in FIG. 1. Avoidance zone device 302 can further include a power source, such as the power source 112 described above and shown in FIG. 1.

Roving device 312 can be, for example, an animal tracking device or an animal control device, for example incorporated into an animal collar. The roving device 312 can include a processor 314, memory 316, location transceiver 318, and wireless communications 320. Wireless communications 320 can be configured to communicate with avoidance zone device 302 and/or server 322 through any suitable communications protocol or combination thereof. The roving device 312 can be configured to receive the position, orientation, and definition of the avoidance zone from the avoidance zone device 302 by way of wireless communications 320. The location transceiver 318 can be any suitable transceiver for determining a location of the roving device 312, for example a GNSS transceiver. In an embodiment, the roving device 312 can be further configured to use real-time or post-processing kinematics to further enhance an accuracy of the determination of the position of the roving device 312. In an embodiment, the processor 314 can be configured to receive the position, orientation, and definition of the avoidance zone received at wireless communications 320 and determine, based on data from the location transceiver 318, whether the roving device 312 has entered an avoidance space. In an embodiment, the processor 314 can further be configured to provide a stimulus based on the determination of whether the roving device 312 has entered the avoidance space.

Optionally, avoidance device 302 and/or roving device 312 can be connected to server 322, for example by way of an internet connection. In an embodiment, the server 322 can be a remote server such as a cloud server. In an embodiment, the server 322 can be configured to receive the location and the orientation of the avoidance zone device 302, either from the avoidance zone device 302 itself, or from the roving device 312. The server 322 can be configured to determine an avoidance space based on the location and orientation of the avoidance zone device 302 and a definition of the exclusion zone including, for example the shape and/or size thereof. The server 322 can determine whether the roving device has entered the avoidance space based on the location of the roving device 312 and the avoidance space. Server 322 can optionally communicate to the roving device 312 whether said roving device 312 has entered an avoidance space. Server 322 can optionally be configured to instruct the roving device 312 to provide a stimulus based on the determination of whether the roving device 312 entered the avoidance space. Server 322 can optionally be configured to record whether the roving device 312 has entered the avoidance space. Server 322 can optionally be configured to provide a notification of the roving device 312 entering the avoidance space to another device, for example by way of a text message, email, an automated phone call, a push notification in an application, or any other suitable such notification of the determination that the roving device 312 has entered the avoidance space.

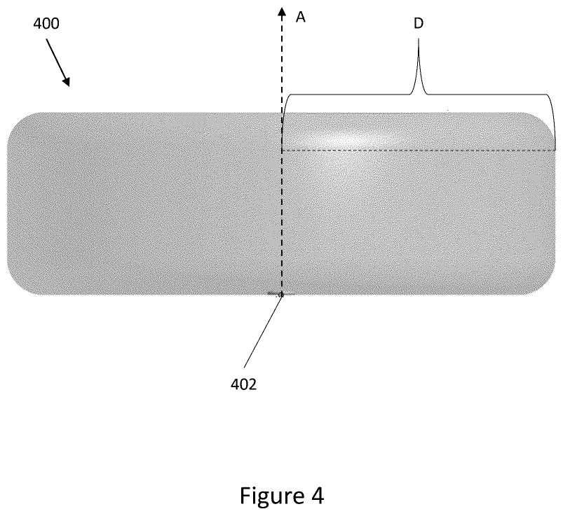

FIG. 4 illustrates an avoidance zone defined by an avoidance zone device according to an embodiment. Avoidance zone 400 is defined with reference to the avoidance zone device 402. The avoidance zone 400 is defined according to a definition obtained by the avoidance zone device 402. The avoidance zone 400 can have any suitable shape according to the definition, such as a cylindrical shape. The definition of avoidance zone 400 can include dimensions thereof, for example a diameter of the avoidance zone D about a central axis A. In an embodiment, other dimensions can be used in addition to the diameter of the avoidance zone 400. For example, the avoidance zone 400 shown in FIG. 4 has a defined height H. The defined height H can be, for example, received through a control interface of the avoidance zone device 402, for example the control interface 106 as described above and shown in FIG. 1A. In embodiments, the avoidance zone can have a pre-set or assumed height, be assumed to have an infinite height, or the like. The avoidance zone 400 can be defined relative to the avoidance zone device 402 and the orientation thereof. For example, the height of the avoidance zone 400 can extend in the direction perpendicular to the plane of the avoidance zone device 402, and a diameter of the avoidance zone 400 can be defined in plane with the avoidance zone device 402. In an embodiment, the avoidance zone 400 can be positioned such that central axis A of the avoidance zone 400 extends from a center of the avoidance zone device 402.

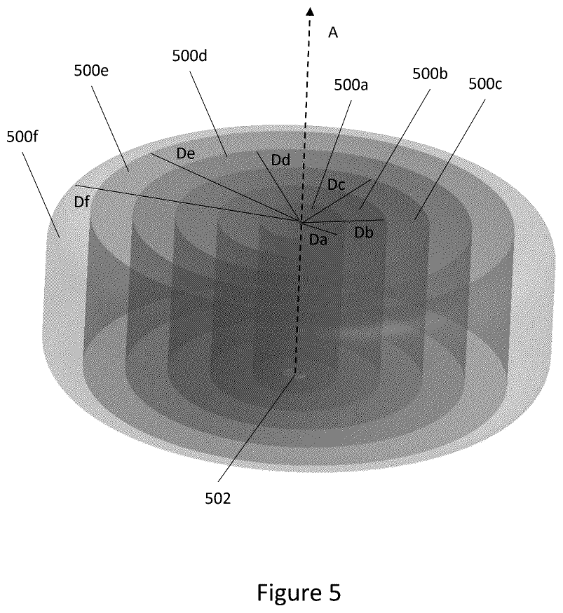

FIG. 5 illustrates avoidance zones defined by an avoidance zone device according to an embodiment. Each of avoidance zones 500a-f shown in FIG. 5 have the same height value H. The avoidance zones 500a-f each have a different respective diameter, Da-Df. The respective diameters Da-Df can be defined using the control interface of the avoidance zone device 502, for example being set by way of manual input, being received from a mobile device application or a system controller, or the like. The avoidance zones 500a-f are concentric, each being centered on the avoidance zone device 502. As shown in FIG. 5, an avoidance zone device 502 can be used to generate avoidance zones 500a-f having differing sizes, based on variation of the definition of the avoidance zone or any parameters thereof. In embodiments, a shape of the avoidance zone can be varied based on suitable changes to the definition of the avoidance zone.

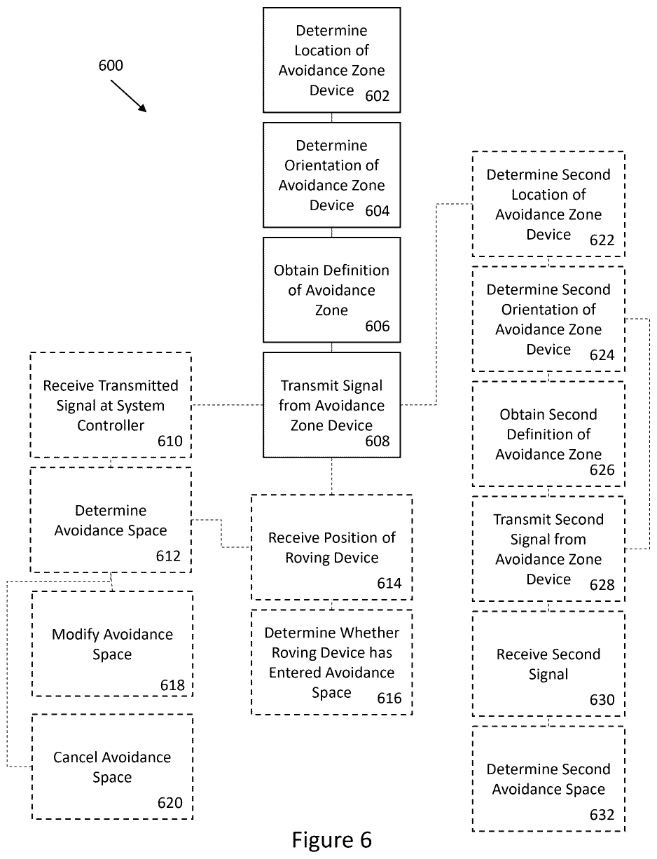

FIG. 6 illustrates a method according to an embodiment. Method 600 includes determining a position of an avoidance zone device 602, determining an orientation of the avoidance zone device 604, obtaining a definition of an avoidance zone 606, and transmitting data from the avoidance zone device at 608.

In the example shown, a position of the avoidance zone device is determined at 602. The position of the avoidance zone device can be determined at 602 using a position sensor. The position sensor can include an ultra-wide-band (UWB) transceiver, a global navigation satellite systems (GNSS) transceiver, a Bluetooth transceiver such as a Bluetooth Low Energy (BLE) transceiver, or the like. In embodiments, the position sensor can determine a position of the avoidance zone device by triangulation relative to a plurality of beacons, for example using one or more of time-of-flight, signal strength, phase shift, or the like.

An orientation of the avoidance zone device is determined at 604. The orientation of the avoidance zone device determined at 604 can be defined based on a plane, axis, or other suitable characteristic of the avoidance zone device. When the avoidance zone device is disc shaped, the orientation determined at 604 can be defined based on an extending direction of an axis perpendicular to a plane of the disc shape of the avoidance zone device. For example, the direction in which the axis perpendicular to the plane of the disc shape of the avoidance zone device extends can be a vertical direction, a horizontal direction, or a direction having both vertical and horizontal components. The orientation of the avoidance zone can be determined at 604 using any suitable orientation sensor included in the avoidance zone device, for example a sensor including an accelerometer, a gyroscope, or the like.

A definition of an avoidance zone can be obtained at 606. In an embodiment, the definition of the avoidance zone can be obtained at the avoidance zone device, for example through manual input at a control interface of the avoidance zone device or through communications of the control interface with a system controller, an application on a mobile device, or the like. In an embodiment, the definition of the avoidance zone can be obtained at a system controller, for example through input at a user interface thereof or through an application interfacing with the system controller, such as an application on a mobile device. In an embodiment, the definition of the avoidance zone can be obtained at a server such as a cloud server, for example through an application interfacing with the server, such as an application on a mobile device. In an embodiment, the definition of the avoidance zone can be obtained at a server. The application can present a user interface such as a prompt for input and accept the input of at least one parameter defining size and/or shape of the avoidance zone. The definition of the avoidance zone obtained at 606 can include a size and/or shape of the avoidance zone. In an embodiment, the shape of the avoidance zone is predetermined, such as a cylindrical shape. The size of the avoidance zone can be based on one or more parameters, for example a diameter and a height for a cylindrical avoidance zone. In an embodiment, one or more of the parameters for the size of the avoidance zone can be predetermined or an assumed value, such as a predetermined height for a cylindrical avoidance zone. In an embodiment, at least one parameter defining a size of the avoidance zone can be based on a user input, such as selection of a diameter for a cylindrical avoidance zone. For other shapes, suitable parameters defining the size of the shape can be used instead of or in addition to diameter and height.

Data is transmitted from the avoidance zone device at 608. In an embodiment, the data includes the position of the avoidance zone device determined at 602 and the orientation of the avoidance zone device determined at 602. The data can be transmitted from the avoidance zone device at 608 so as to be received at one or more of a system controller, a roving device, a server, a mobile device running an application, or the like. The data can be transmitted by way of a signal transmitted from the avoidance zone device directly to a system controller or a roving device, or can be transmitted to the system controller, roving device, server, and/or mobile device by any one or more suitable wireless communications protocols such as Wi-Fi, cellular data communications, BlueTooth, BlueTooth Low Energy, NFC, an internet connection, combinations thereof, or the like.

Optionally, method 600 can further include receiving the data transmitted from the avoidance zone device at 608 at a system controller at 610. The system controller can receive the data at 610 directly by receiving a transmission from the avoidance zone device, or through one or more other devices or communications pathways such as a Wi-Fi network, internet connection, or the like. The system controller can obtain at least the position and the orientation of the avoidance zone device from the data received at 610. In an embodiment, the system controller further obtains the definition of the avoidance zone from the data received at 610. The system controller can determine an avoidance space at 612. Determining the avoidance space at 612 can include defining a volume in three-dimensional space having a size and shape based on the definition of the avoidance zone and positioned in three-dimensional space according to the position and orientation of the avoidance zone device. The determined avoidance space can be saved in a memory of the system controller, a server, a mobile device, a roving device, or the like.

Optionally, method 600 can also include receiving position data for a roving device 614 and determining whether the roving device has entered the avoidance zone 616. In an embodiment, the position data can be received at 614 by a system controller, and the system controller can determine whether the roving device has entered the avoidance zone at 616 by comparing the position data received at 614 to the avoidance space. In an embodiment, the roving device can receive the position, orientation, and definition of the avoidance zone transmitted by the avoidance zone device at 608 and determine, further based on the position data received at 614, whether the roving device has entered the avoidance space at 616. In another embodiment, the roving device can receive the position, orientation, and definition of the avoidance zone transmitted by the avoidance zone device at 608 and transmit the position, orientation, and definition of the avoidance zone to a server. The server can also receive the position data for the roving device and determine whether the roving device has entered the avoidance space at 616. In an embodiment, when the roving device has been determined to have entered the avoidance space, the roving device can provide a suitable stimulus to the wearer of said roving device.

In an embodiment, the method 600 can further include modifying the avoidance space 618 or cancelling the avoidance space 620. The avoidance space can be modified at 618 by moving the avoidance zone device to a new position and/or orientation, and/or changing at least one parameter of the definition of the avoidance zone. In an embodiment, modifying the avoidance space at 618 can include instructing a device such as a system controller or a server to modify the avoidance space according to the new position and/or orientation, and/or any changes to the definition of the avoidance zone, for example through user input, in response to a trigger, at particular times for periodic refreshing of avoidance spaces, or the like. In an embodiment, the avoidance space can be cancelled at 620. Cancelling the avoidance space at 620 can include deactivating the avoidance zone device and/or instructing a system controller, remote server, roving device or the like to remove the avoidance space from memory and/or cease determining whether the roving device has entered the avoidance space cancelled at 620.

Optionally, method 600 can include using the avoidance zone device to determine a second avoidance space. The second avoidance space can be determined based on a changed position and/or orientation of the avoidance zone device, for example following a user moving the avoidance zone device to the new position and/or orientation. The optional determination of the second avoidance space can include determining a second position of an avoidance zone device 622 and determining a second orientation of the avoidance zone device 624. The second position can be determined at 622 using the position sensor of the avoidance zone device. The second orientation can be determined at 624 using the orientation sensor of the avoidance zone device.

The method 600 can also optionally include obtaining a second definition of the avoidance zone 626. The second definition of the avoidance zone can be obtained at the avoidance zone device, for example through manual input at a control interface of the avoidance zone device or through communications of the control interface with a system controller, an application on a mobile device, or the like. In an embodiment, the second definition of the avoidance zone can be obtained at a system controller, for example through input at a user interface thereof or through an application interfacing with the system controller, such as an application on a mobile device. In an embodiment, the second definition of the avoidance zone can be obtained at a server such as a cloud server, for example through an application interfacing with the server, such as an application on a mobile device. In an embodiment, the definition of the avoidance zone obtained at 606 can be used instead of obtaining a second definition of the avoidance zone at 626, for example, when no change has been made at a control interface of the zone, at a system controller, or at a server.

Method 600 can also include transmitting second data 628 from the avoidance zone device, the second data including the second position of the avoidance zone device and the second orientation of the avoidance zone device, and optionally the second definition of the avoidance zone. In an embodiment, the method 600 can further include receiving the second data 630, and determining a second avoidance space 632. The second data can be received at 630 at the system controller, the roving device, and/or at the server. The second data can be used to determine the second avoidance space at 632. The second avoidance space is an area in three-dimensional space according to the second position and the second orientation of the avoidance zone device, and having a shape and size according to the definition of the avoidance zone or the second definition of the avoidance zone. In an embodiment, the second avoidance space can be stored in a memory, such as a memory of the system controller, the roving device, the server, in addition to the avoidance space, thereby allowing one avoidance zone device to be used to establish multiple avoidance spaces.

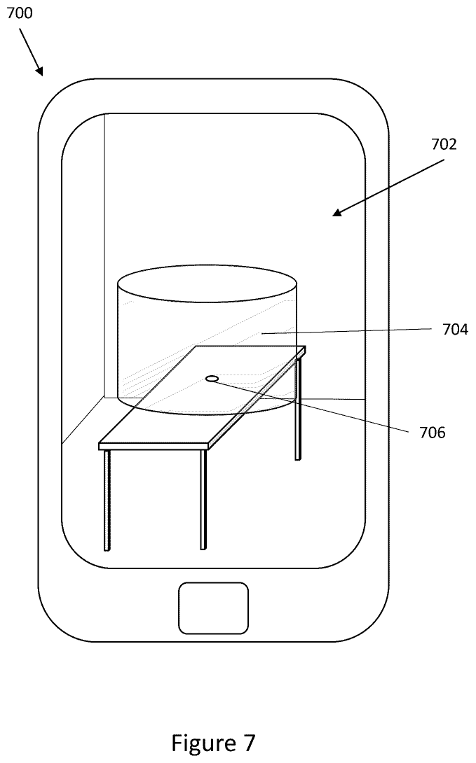

FIG. 7 shows a user interface including a visualization of an avoidance zone according to an embodiment. User interface 700 can display a scene 702 and one or more avoidance zones 704. User interface 700 can be provided on a display, such as a screen of a mobile device, a monitor of a computer, a display integrated with a system controller, or the like. Scene 702 depicts a location including the one or more avoidance zones 704 defined using one or more avoidance zone devices 706. Scene 702 can be an image of a location, such as one or more photographs, a real-time view of the location for example as captured by a camera of a mobile device, or a representation of the location such as a three-dimensional model, a two-dimensional representation such as a floorplan, or the like. The position of the location depicted in the scene 702 can be, for example, predetermined values such as coordinates for floorplans or models of spaces, obtained from data or metadata included in digital images, based on location services of a device capturing the scene 702, or the like. The one or more avoidance zones 704 can be shown overlaid on scene 702 in the user interface 700. The avoidance zone(s) 704 can be overlaid on the scene 702 according to the position, orientation, shape and size of the avoidance zones 704 relative to the position of the location depicted in the scene 702. The avoidance zones 704 can be overlaid in any suitable manner for the nature of the scene, for example being overlaid onto a real-time image of the scene 702 to provide an augmented reality view, inserted into one or more images, included as objects in a three-dimensional model or floorplan, or the like.

While particular uses of the technology have been illustrated and discussed above, the disclosed technology can be used with a variety of devices in accordance with many examples of the technology. The above discussion is not meant to suggest that the disclosed technology is only suitable for implementation with the specific avoidance device, system controller, roving device, or circuitry and components thereof as shown and described above. For example, while certain technologies described herein were primarily described in the context of an animal collar or animal tracking device, aspects of the present disclosure are not so limited.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. An avoidance zone device, comprising:
a position sensor configured to obtain a position of the avoidance zone device;
a control interface configured to receive a definition of an avoidance zone; and
a transmitter configured to transmit data including the position of the avoidance zone device, the orientation of the avoidance zone device, and the definition of the avoidance zone.

2. The avoidance zone device of claim 1, wherein the avoidance zone device is disc shaped.

3. The avoidance zone device of claim 1, wherein the position sensor includes at least one of an ultra-wide-band (UWB) transceiver or a global navigation satellite system (GNSS) transceiver.

4. The avoidance zone device of claim 1, further comprising an orientation sensor configured to determine an orientation of the avoidance zone device, wherein the orientation sensor includes an accelerometer.

5. The avoidance zone device of claim 1, wherein the definition of the avoidance zone includes a diameter of the avoidance zone.

6. The avoidance zone device of claim 1, wherein the definition of the avoidance zone includes a height of the avoidance zone.

7. The avoidance zone device of claim 1, wherein the control interface is configured to receive manual input of the definition of the avoidance zone.

8. The avoidance zone device of claim 1, wherein the control interface is configured to receive the definition of the avoidance zone by wireless communications.

9. A system, comprising:
an avoidance zone device, the avoidance zone device including:
a position sensor configured to obtain a position of the avoidance zone device;
an orientation sensor configured to determine an orientation of the avoidance zone device;
a transmitter configured to transmit data including the position of the avoidance zone device and the orientation of the avoidance zone; and
a system controller, the system controller including:
a processor, the processor configured to:
receive the position of the avoidance zone device, the orientation of the avoidance zone device, and a definition of the avoidance zone; and
determine an avoidance space based on the position of the avoidance zone device, the orientation of the avoidance zone device, and the definition of the avoidance zone; and
a memory configured to store the avoidance space.

10. The system of claim 9, wherein the system controller is configured to receive the data including the position of the avoidance zone device, the orientation of the avoidance zone device, and the definition of the avoidance zone from the avoidance zone device.

11. The system of claim 9, wherein the system controller is configured to receive a second position of the avoidance zone device, a second orientation of the avoidance zone device, and a second definition of the avoidance zone, and determine a second avoidance space based on based on the position of the avoidance zone device, the orientation of the avoidance zone device, and the definition of the avoidance zone.

12. The system of claim 9, further comprising an application executable on a processor of a mobile device, wherein the application and at least one of the system controller or the avoidance zone device are configured to communicate through wireless communications.

13. The system of claim 12, wherein the application is configured to receive the position of the avoidance zone device and the orientation of the avoidance zone device, and the system controller is configured to receive the position of the avoidance zone device, the orientation of the avoidance zone device, and the definition of the avoidance zone from the application.

14. The system of claim 12, wherein the application is configured to obtain the definition of the avoidance zone and the system controller is configured to receive the definition of the avoidance zone from the application.

15. The system of claim 12, wherein the application is configured to display an augmented reality view of a location including at least a portion of the avoidance space, the augmented reality view showing the avoidance space.

16. The system of claim 9, further comprising a roving device, the roving device including a position sensor configured to determine a position of the roving device and a transmitter configured to transmit the determined position of the roving device,
wherein the system controller is configured to receive the determined position of the roving device, and
the system controller is configured to determine whether the determined position of the roving device is within the avoidance space.

17. A method, comprising:
determining a position of an avoidance zone device using a position sensor included in the avoidance zone device;
obtaining a definition of an avoidance zone using a control interface of the avoidance zone device; and
transmitting, from the avoidance zone device, data including the position of the avoidance zone device and the definition of the avoidance zone.

18. The method of claim 17, further comprising:
receiving the data at a system controller; and
determining, at the system controller, an avoidance space based on the position of the avoidance zone device and the definition of the avoidance zone.

19. The method of claim 18, further comprising receiving, at the system controller, position data from a roving device, and determining, at the system controller, whether the roving device has entered the avoidance zone.

20. The method of claim 18, further comprising:
determining an orientation of the avoidance zone device using an orientation sensor included in the avoidance zone device, wherein the data transmitted from the avoidance zone device further includes the orientation of the avoidance zone device;
determining a second position of an avoidance zone device using the position sensor included in the avoidance zone device;
determining a second orientation of the avoidance zone device using the orientation sensor included in the avoidance zone device;
transmitting, from the avoidance zone device, second data including the second position of the avoidance zone device and the second orientation of the avoidance zone device;
receiving the second data at the system controller; and
determining, at the system controller, a second avoidance space based on the second position of the avoidance zone device and the second orientation of the avoidance zone device.
